(19) United States
(12) Patent Application Publication
(10) Pub. No.: US 2010/0023870 A1
(43) Pub. Date: Jan. 28, 2010

(54) APPARATUS AND METHOD FOR INTEGRATED MANAGEMENT OF CLINICAL TRIALS AND STUDIES AT AN IRB

(76) Inventor: Matthew R. Baker, Mesa, AZ (US)

Correspondence Address: Wright Law Group, PLLC, Suite 2, 7201 West Oakland, Chandler, AZ, 85226, US

(21) Appl. No.: 12/431,600

(22) Filed: Apr. 28, 2009

Related U.S. Application Data
(60) Provisional application No. 61/048,514, filed on Apr. 28, 2008.

(51) Int. Cl. G06Q 10/00; G06Q 50/00; G06F 3/048; G06F 17/30; H04L 9/32

(52) U.S. Cl. 715/742; 705/3; 707/104.1; 707/9

(57) ABSTRACT

The apparatus and methods of the present invention implement a computer-based system and procedure for the efficient and effective operation of one or more clinical trials using an IRB. The various methods are deployed against the backdrop of an Internet-based Software As A Service (SaaS) platform, allowing access to the system by all relevant participants. Each authorized participant in the clinical trial can have a customized and customizable view of the clinical trial and interact with the other participants electronically. The various documents required for completion of the clinical trial or study, as well as the various compliance documents needed to satisfy regulatory agencies are all available for review via the Internet. By utilizing the methods and system of the present invention, greater protection is offered for the human subjects of the clinical trials. Further, the sponsors, investigators, and the study participants can experience increased productivity. Finally, FDA mandated information can be more readily tracked and, accordingly, compliance with FDA guidelines can be enhanced.

### RELATED APPLICATIONS

The present application is a non-provisional patent application and claims priority benefit, with regards to all common subject matter, of earlier-filed U.S. provisional patent application Ser. No. 61/048,514 filed on Apr. 28, 2008 and entitled “APPARATUS AND METHOD FOR IRB MANAGEMENT.” The identified earlier-filed provisional patent application is hereby incorporated by reference into the present application.

### BACKGROUND OF THE INVENTION

1. Field of the Invention

This invention relates generally to the field of clinical drug and device trials monitored by an independent or institutional review board (IRB) and more specifically relates to a novel approach for computerized integration and management of IRB operational activities.

2. Background Art

In the United States, the Department of Health and Human Services oversees the protection of the health of the citizens of the United States. Under the auspices of the DHHS, other government agencies such as the Food and Drug Administration (FDA) and the Office of Human Subject Research Protection (OHRP) will generally oversee the protection of consumers exposed to health-related products ranging from food, cosmetics, drugs, gene therapies, and medical devices. Under the guidance of either OHRP or the FDA, clinical trials are performed to test the safety and efficacy of new drugs, medical devices or other treatments to ultimately ascertain whether or not a new medical therapy is appropriate for widespread application in the human population.

More specifically, once a new drug or medical device has undergone studies in animals, and results appear favorable, it can then be studied in humans. Before human testing begins, findings of animal studies are reported to the FDA to obtain approval to do so. This report to the FDA is called an application for an Investigational New Drug (IND). In general, the clinical trials for new devices and drugs are sponsored by pharmaceutical and medical device manufacturers, commonly known as in the industry as “Sponsors.” For each trial, the Sponsor will typically identify a “Service Provider” to manage the trial for the Sponsor. The Service Provider is generally a person employed by the Sponsor and the Service Provider will interact with the IRB to monitor the progress of the clinical trial from inception to completion. In other situations, the Service provider may be third party contract research organization (“CRO”) who is engaged by the Provider to perform the functions of the Service Provider.

Most clinical trials involve four phases. In Phase I, a few research participants, referred to as subjects, (generally 5 to 10) are used to determine toxicity or relative safety of new drugs, treatments, compounds, and/or medical devices. Additionally, studies may be performed to gather new information about existing products, in order to generate data for new indications or applications of the existing product. In Phase II, more subjects (generally 10 to 20) are used to determine efficacy and further ascertain safety. Doses and treatment methodologies are stratified to try to gain information about the optimal implementation or application.

During the clinical trial, the experimental drug, treatment or device may be compared to either a placebo or another existing therapy and/or various control groups. In Phase III, efficacy is determined. For this phase, it is more common to employ a significantly larger group of subjects, on the order of hundreds or even thousands of patients, to perform a meaningful statistical analysis. In Phase IV (post-approval study), the treatment has already been approved by the FDA, but more testing is performed to evaluate long-term effects and to evaluate other indications.

During one or more of the clinical trials, patients are seen at medical clinics or offices (typically called “Companies”) and may be asked to participate in a clinical research project by a doctor, generally known as the “Investigator.” After the patients sign an informed consent form, they may be enrolled in the study, and are typically referred to as study subjects. A study sponsor, generally considered to be the company developing a new medical treatment and supporting the research, develops a study protocol for use in testing.

In general, the study protocol is a document describing the reason for the experiment, the rationale for the number of subjects required, the methods used to study the subjects, and any other guidelines or rules for how the study is to be conducted to achieve the desired results. Prior to implementation, certain aspects of the study protocol are reviewed and approved by an IRB. An IRB serves as a type of review group, and evaluates a protocol to determine its soundness and ethical approach, focusing on the protection of the subjects. The main purpose of the IRB is not to evaluate the protocol from a medical or scientific perspective, but to evaluate the clinical trial from an ethics and safety perspective, with the welfare of the human subjects as the primary concern. In this fashion, the IRB provides oversight and guidance for the testing protocol to ensure that informed consent is obtained and that the safety of the human subjects is properly considered at every step along the way.

The IRB generally serves as the focal point for the oversight of the clinical trial and will usually provide a communication interface for the sponsor of the study, the companies and investigators conducting the clinical trial, and, in certain circumstances, the subjects who are participating in the clinical trial. In order to properly perform its function, the IRB is required to generate and maintain a significant amount of study documentation and related correspondence. Given the sometimes lengthy and complex nature of clinical trials, this task can become challenging. For example, before any clinical trial or study can commence, the informed consent document must be reviewed by the IRB to ensure that the potential subjects are properly and adequately informed of all of the potential risks or hazards associated with participation in the trial or study.

Similarly, the study protocol is reviewed by the IRB to ensure that the health and safety of the participants is properly protected during the clinical trial. Additionally, as a further safeguard, any proposed change in a previously approved study protocol must undergo a thorough review by the IRB prior to implementation. All of these activities, and dozens of other required procedures, involve communication and cooperation between the sponsor, the investigators, and the participants, all of which is orchestrated and monitored by the IRB. Under current practice for most IRBs, this means that communication is fragmented, disjointed, and often the source of delay, frustration, and mistake.

All of the actions taken by the participants in the clinical trial or study must be thoroughly documented and monitored to ensure that the FDA will not only approve of the final results of the study, but that the study is actually conducted in the prescribed fashion so as to ensure the health and safety of the participants. In order for this to be accomplished, the IRB must continually communicate with each Company and, on occasion, the Service Provider and/or the participants. All of the activities and communications, including required forms and approval letters, progress reports, etc. must be conducted and records maintained in an FDA-approved manner. Failure to do so will invalidate the study and, in certain situations, precipitate FDA sanctions.

While the basic processes and procedures for conducting the clinical trial or study are set forth in various FDA rules, regulations, and guidance documents, the actual implementation of the clinical trial and study, along with the documentation that must be maintained, is subject to whatever disparate methods and procedures that the various study-related entities choose to employ. Given the large number of sponsors, studies, investigators, and studies being conducted at any one time, there is a wide variation in the methods, processes, procedures, and forms used by the participants. The lack of cohesive standards for communication, document processing, exchange, and storage, coupled with the ever-present organizational and personnel issues, can lead to many wasted hours and potential missteps during the actual completion of the clinical trial. In addition, under current practice for most IRBs, these problems frequently result in communication that is fragmented, disjointed, and that may be the source of significant delay, frustration, and mistake.

To further complicate matters, other entities may become involved in the clinical trial process. For example, in addition to the previously mentioned entities and participants, there are also Site Management Organizations (“SMOs”) that may also facilitate the overall management of one or more studies. The role of the SMO is to generally handle the administrative burden of the company conducting the trial, so as to allow the company to focus on the medical aspects of the trial and not the administrative tasks. While the addition of an SMO can be beneficial in many instances, the introduction of yet another participant in the clinical trial process inevitably leads to yet another layer of communication and interactive complexity.

This may lead to further operational inefficiencies as the IRB tries to bring a cohesive model to the process of conducting the clinical trial, with the involvement of each party presenting its own set of challenges. Since each party has their own pre-existing processes and procedures in place, it is often the responsibility of the IRB to reformulate and redirect the efforts of the disparate operational entities. While monitoring the process and ensuring that the study protocol is followed, sometimes the activities involved in the administrative efforts can overshadow the efforts made in actually completing the study. To the extent that these operational and organizational distractions take center stage, the IRB will be required to spend a significant amount of time and energy to keep the clinical trial on track for successful and timely completion.

Those skilled in the art will recognize that the current systems and procedures for operating an IRB leave significant room for improvement. The sometimes haphazard nature of the ad-hoc communications flow, spread amongst various constituencies, each with the own objectives, processes and procedures, coupled with the inefficient shuffling of paper-based documents, can easily lead to less than satisfactory results. Without additional improvements in the management aspects of IRB operational procedures for conducting clinical trials and studies, the safety and efficiency of most clinical trials will continue to be sub-optimal.

### SUMMARY OF THE INVENTION

The apparatus and methods of the present invention implement a computer-based system and procedure for the efficient and effective operation of one or more clinical trials using an IRB. The various methods are deployed against the backdrop of an Internet-based Software As A Service (SAAS) platform, allowing access to the system by all relevant participants. Each participant in the clinical trial can have a customized and customizable view of the clinical trial and interact with the other participants electronically. The various documents required for completion of the clinical trial or study, as well as the various compliance documents needed to satisfy regulatory agencies are all available for review via the Internet. By utilizing the methods and system of the present invention, greater protection is offered for the human subjects of the clinical trials. Further, the sponsors, investigators, and the study participants can experience increased productivity. Finally, FDA mandated information can be more readily tracked and, accordingly, compliance with FDA guidelines can be enhanced.

### BRIEF DESCRIPTION OF THE DRAWINGS

The various preferred embodiments of the present invention will hereinafter be described in conjunction with the appended wherein like designations denote like elements and:

FIG. 1 is a block diagram of a computer-based system for providing customized IRB operational management in accordance with a preferred embodiment of the present invention;

FIG. 2 is a block diagram of a computer used to provide a customized IRB operational management system for clinical trials in accordance with a preferred embodiment of the present invention;

FIG. 3 is a relational diagram depicting the interaction of various entities using a customized IRB operational management system for clinical trials in accordance with a preferred embodiment of the present invention;

FIG. 4 is a flow chart for a method of adding a clinical trial to a customized IRB operational management system for clinical trials in accordance with a preferred embodiment of the present invention;

FIG. 5 is a flow chart for a method of providing a Company with access to a clinical trial using a customized IRB operational management system for clinical trials in accordance with a preferred embodiment of the present invention;

FIG. 6 is a user interface for using a customized IRB operational management system for clinical trials in accordance with a preferred embodiment of the present invention;

FIG. 7 is a user interface for using a customized IRB operational management system for clinical trials in accordance with a preferred embodiment of the present invention;

FIG. 8 is a user interface for using a customized IRB operational management system for clinical trials in accordance with a preferred embodiment of the present invention; and

FIG. 9 is a user interface for using a customized IRB operational management system for clinical trials in accordance with a preferred embodiment of the present invention.

### DETAILED DESCRIPTION

The apparatus and methods of the present invention are deployed within the specific confines of the IRB community. In general, the various preferred embodiments of the apparatus and method of the present invention are offered via the Internet in a Software as a Service (SaaS) application for use by multiple entities engaged in the operation and management of clinical trials. In order to ensure proper understanding of the detailed description presented below, certain entities and individuals, along with their respective roles, are set forth below.

Administration Entity. An Administration Entity is typically a staff member working at an IRB offering the computer-based system for providing customized IRB operational management. The Administration Entity will be involved in various activities related to managing the flow of documents and information related to the clinical trial.

Company Study Registration (CSR). A record that a Company has been registered for a given study. Each CSR is a registration number that identifies a specific combination of a study and a Company that is registered to participate in that study.

Company. A Company is typically a doctor's office or group of physicians that conducts studies or trials, for and on behalf of one or more Sponsors. Each Company will generally comprise at least two specific elements: Investigator(s) and location(s).

Investigator. An Investigator is a medical professional employed by a Company that has been engaged by a Sponsor to conduct a clinical trial. More than one Investigator may be used, with one of the Investigators typically being identified as the Lead Investigator.

Service Provider (SP). A Service Provider is generally a person working for the Sponsor and who serves as the project manager for a given study or clinical trial. Every time a new project is initiated, the Service Provider will be identified by the Sponsor and the Service Provider will be the point of contact for the Sponsor with the IRB. As with the Service Provider, the SPA may also be a third party contracted by the Sponsor to perform the SPA function.

Service Provider Administrator (SPA). A Service Provider Administrator is generally a person working for the Sponsor who serves as the SP for multiple studies or clinical trials that are being conducted simultaneously.

Site. A Site is the physical location where a study or clinical trial is conducted and the Site will be under the direction of an Investigator. A given study or clinical may be conducted at more than one Site, with more than one Investigator at each Site.

Site Management Organization (SMO). A Site Management Organization is an entity that specializes in managing the paperwork and administrative functions for a Company that is involved in clinical trials. Many Companies prefer to allow a third party to manage all the administrative functions of a study. The benefit to a Company for using an SMO is that it allows the Company to concentrate on “patients” and not “paperwork.” Given this understanding of the participants in the IRB monitored management of medical studies and clinical trials, the substance of the invention can be described.

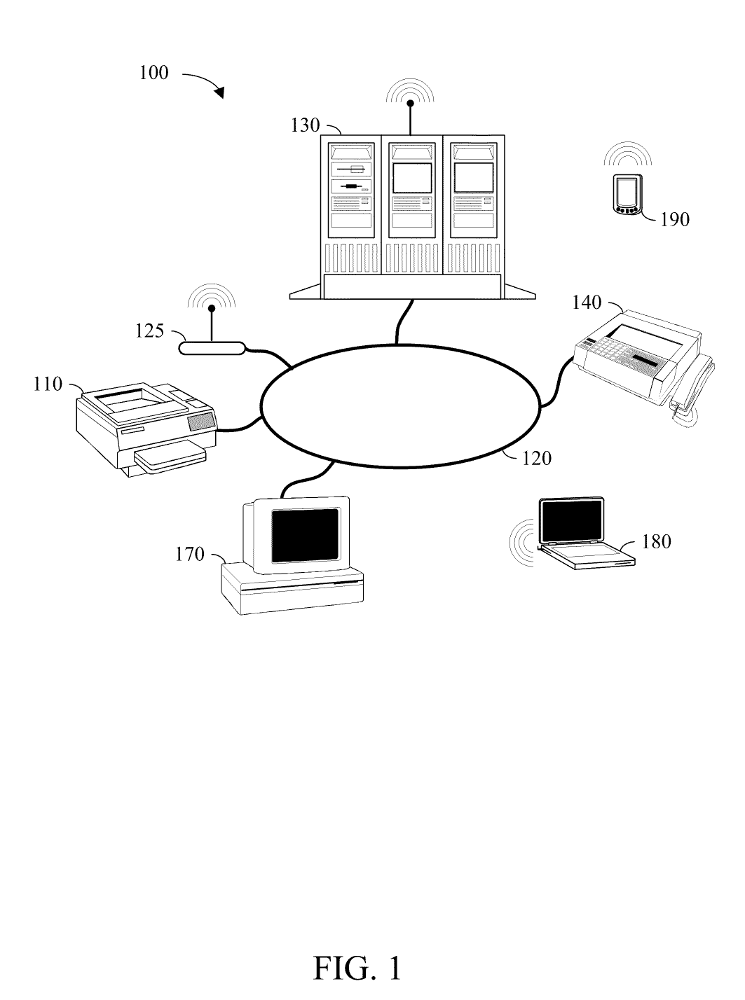

Referring now to FIG. 1, a block diagram of a computer-based system 100 for providing customized IRB operational management in accordance with a preferred embodiment of the present invention comprises: a data server 130; an information requesting computer system 170; an information providing computer system 180; and a personal digital assistant 190, all connected or coupled via a network 120. Additionally, an optional printer 110 and an optional fax machine 140 are shown. Taken together, the various components of computer-based system 100 provides a way for individuals, organizations, businesses, and the like to more efficiently and effectively create, customize, process, exchange, and manage access to information, specifically contact information, as described herein in conjunction with the various preferred embodiments of the present invention.

Data server 130 represents a relatively powerful computer system that is made available to information requesting computer system 170, information providing computer system 180, and personal digital assistant 190 via network 120. Various hardware components (not shown this FIG.) such as external monitors, keyboards, mice, tablets, secondary storage devices, hard disk drives, recordable CD-ROM/DVD drives and/or burners, jukeboxes, fax servers, magnetic tapes, and other devices known to those skilled in the art may be used in conjunction with data server 130. Data server 130 may also include various software components (not shown this FIG.) such as database servers, web servers, firewalls, security software, and the like. The use of these various hardware and software components is well known to those skilled in the art. Given the relative advances in the state-of-the-art computer systems available today, it is anticipated that the various functions of data server 130 may be provided by many standard, readily available data servers. Depending on the desired size and relative power required for data server 130, storage area network (SAN) technology may also be deployed in certain preferred embodiments of the present invention.

Information requesting computer system 170 and information providing computer 180 may be any type of computer system known to those skilled in the art that is capable of being configured for use with computer-based system 100 as described herein. This includes laptop computers, desktop computers, tablet computers, pen-based computers and the like. Additionally, handheld and palmtop devices are also specifically included within the description of devices that may be deployed as an information requesting computer system 170. It should be noted that no specific operating system or hardware platform is excluded and it is anticipated that many different hardware and software platforms may be configured to create information requesting computer system 170. As previously explained in conjunction with data server 130, various hardware components and software components (not shown this FIG.) known to those skilled in the art may be used in conjunction with information requesting computer system 170. It should be noted that in many preferred embodiments of the present invention, information requesting computer system 170 is linked to its own LAN or WAN and has access to its own data server (not shown this FIG.).

Network 120 is any suitable computer communication link or communication mechanism, including a hardwired connection, an internal or external bus, a connection for telephone access via a modem or high-speed data line (T1, T3, etc.), radio, infrared or other wireless communications, public, private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future. It should be noted that portions of network 120 may suitably include a dial-up phone connection, broadcast cable transmission line, Digital Subscriber Line (DSL), ISDN line, or similar public utility-like access link. Different portions of network 120 may be configured and implemented using any or all of the various options described herein.

In the most preferred embodiments of the present invention, network 120 represents and comprises a standard Internet connection between the various components of computer-based system 100. Network 120 provides for communication between the various components of computer-based system 100 and allows for relevant information to be transmitted from device to device. In this fashion, users of computer-based system 100 can quickly and easily gain access to the relevant data and information as described in conjunction with the preferred embodiments of the present invention. Regardless of physical nature and topology, network 120 serves to logically link the physical components of computer-based system 100 together, regardless of their physical proximity. This is especially important because in many preferred embodiments of the present invention, data server 130, information requesting computer system 170, and information providing computer system 180 may be geographically remote and separated from each other.

Personal digital assistant (PDA) 190 is representative of a class of devices that are at least somewhat less full-featured and less powerful than computers 170 and 180. This includes, for example, Palm OS devices, Pocket PC devices, and various types of “smart phones” for example. Those skilled in the art will recognize these various devices and others that are suitable for deployment as PDA 190. While somewhat less powerful than computers 170 and 180, PDA 190 is also configured to communicate with data server 130 via network 120 to send and retrieve IRB study-related information to and from data server 130. Given the standard functionality for devices that may be deployed as PDA 190, this communication will typically be a wireless Internet connection or a Bluetooth connection. One example of the use for PDA 190 in the context of computer-based system 100 would be an Investigator viewing the status of various study-related documents stored in a database on data server 130. Those skilled in the art will recognize that “smart” handhelds and tablet computers are other devices that are also capable of processing several types of wireless input such as biometric authentication, speech, and handwriting in addition to accepting input from a mouse and keyboard.

In general, data server 130 stores information and processes requests for various transactions, including requests for the information stored on data server 130, between information requesting computer system 170 and information providing computer system 180. A typical transaction may be represented by a request for access to certain information made by one individual or entity relative to another individual or entity. In the most preferred embodiments of the present invention, the request may be made via a web-based application running on data server 130 and accessed by the user of information requesting computer 170 via any standard web browser, using the Internet. In this case, a request for access to certain information is sent from information requesting computer system 170 to data server 130. Data server 130 processed the request, formats the request for processing and, as necessary, transfers the request for access to information providing computer system 180. The request may also generate an automatic response, based on certain pre-set permission parameters associated with and controlled by the owner of the information requested. This request for access to information may be accomplished by any of the methodologies in presented in conjunction with the various preferred embodiments of the present invention described herein.

Upon receiving the request for access to certain information from data server 130, the user of information providing computer system 180 can determine whether or not to grant access to any or all of the information controlled by the user and as requested by information requesting computer 170. The approval or disapproval of the request for access is routed by data server 130 and made available to information requesting computer 170 by any of the methodologies presented in conjunction with the various preferred embodiments of the present invention described herein. Additionally, if the request for access to information is granted, the authorized information may be transmitted from data server 130 to information requesting computer 170. As previously explained, the access to the requested information may also be automatically granted based on pre-established criteria. In the most preferred embodiments of the present invention, the request for access to certain information will typically be answered by providing access to a custom information profile as described in conjunction with the various preferred embodiments of the present invention as describer herein.

It should be noted that the roles of information requesting computer system 170 and information providing computer system 180 may be interchanged, depending on which user initiates the request for access to the information. Additionally, it should be noted that while FIG. 1 shows only a single information requesting computer system 170 and a single information providing computer system 180, it is anticipated that the most preferred embodiments of the present invention may comprise virtually all computers and computer systems that may be connected via computer networks such as the Internet.

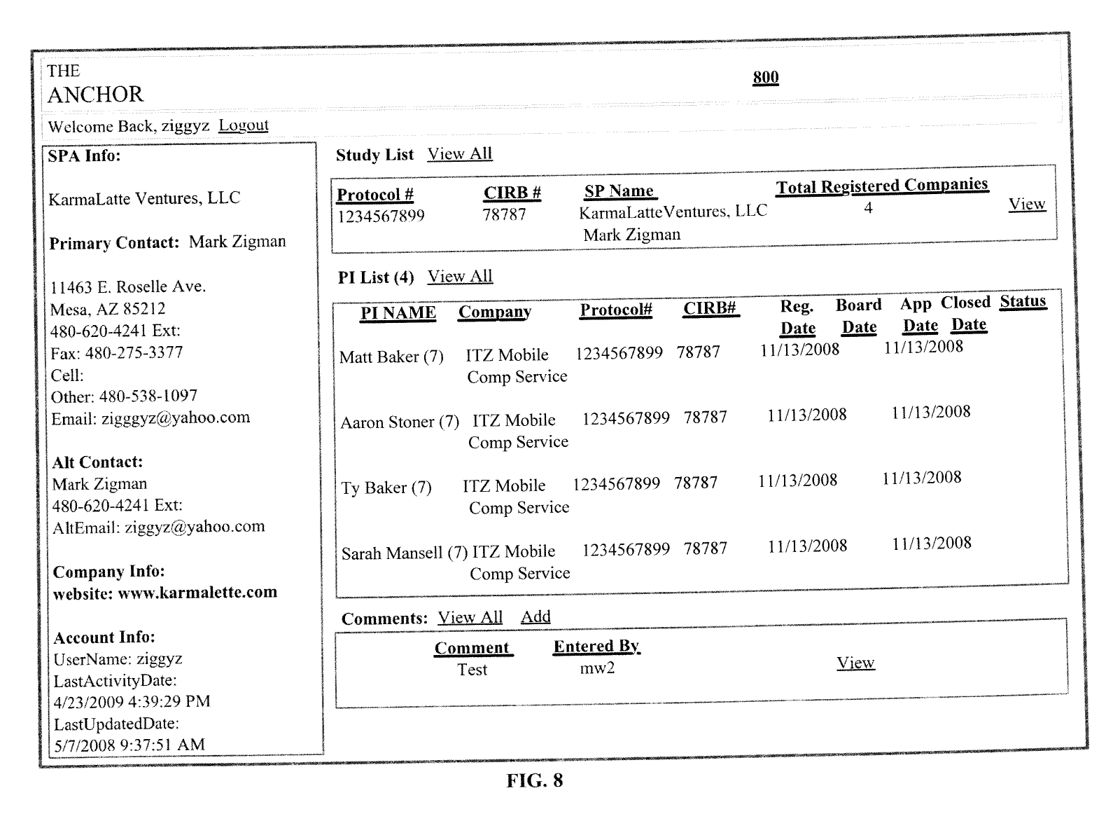

In the most preferred embodiments of the present invention, multiple information requesting computer systems 170 and multiple information providing computer systems 180 will all be configured to communicate with data server 130 and with each other via network 120. In addition, the most preferred embodiments of the present invention include a Software as a Service (SaaS) environment where data server 130 is operated as a clearinghouse in a hosted operation. In this fashion, multiple information requesting computer systems 170 and information providing computer systems 180 may be provided with access to data server 130 on an as-needed basis, using the Internet. Data server 130 is further described below in conjunction with FIG. 8 below.

Optional printer 110 and an optional fax machine 140 are standard peripheral devices that may be used for transmitting or outputting paper-based documents, notes, transactions, reports, etc. in conjunction with the queries and transactions processed by computer-based system 100. Optional printer 110 and an optional fax machine 140 may be directly connected to network 120 or indirectly connected via any or all of information requesting computer systems 170, information providing computer systems 180, and/or data server 130. Finally, it should be noted that optional printer 110 and optional fax machine 140 are merely representative of the many types of peripherals that may be utilized in conjunction with computer-based system 100. It is anticipated that other similar peripheral devices may be deployed in the various preferred embodiment of the present invention and no such device is excluded by its omission in FIG. 1.

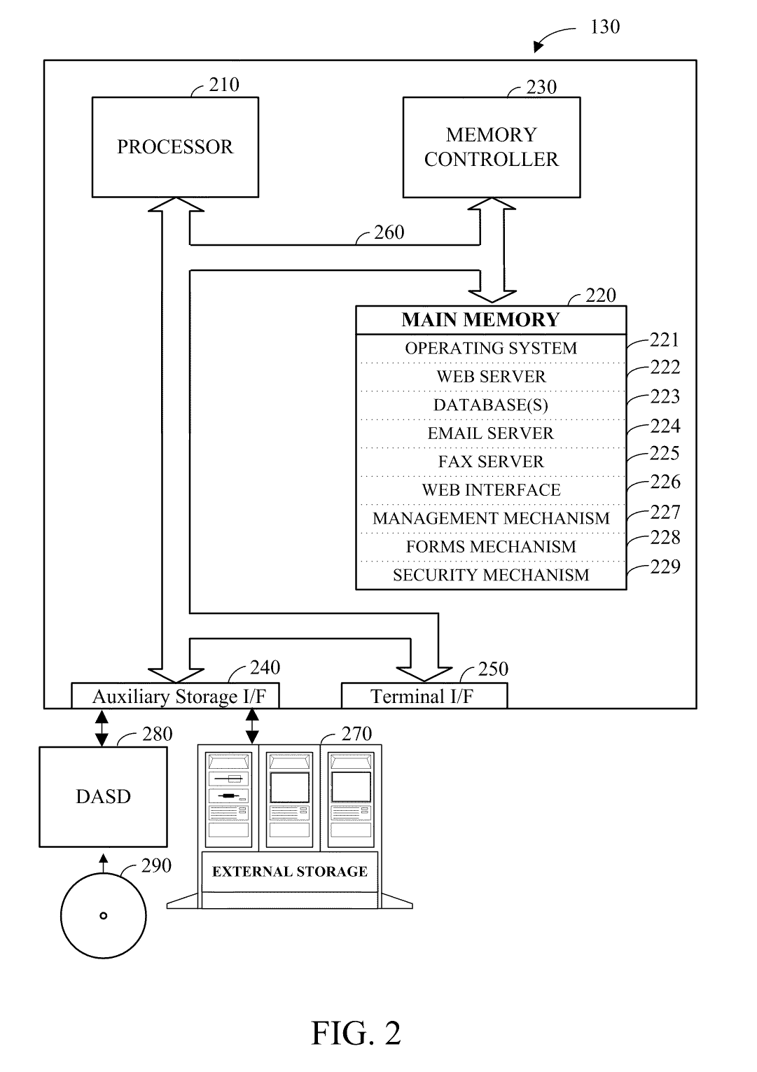

Referring now to FIG. 2, data server 130 in accordance with a preferred embodiment of the present invention is most preferably a commercially available computer system such as a Linux-based computer system, IBM compatible computer system, or Macintosh computer system. However, those skilled in the art will appreciate that the methods and apparatus of the present invention apply equally to any computer system, regardless of whether the computer system is a traditional “mainframe” computer, a complicated multi-user computing apparatus or a single user device such as a personal computer or workstation.

Data server 130 suitably comprises at least one Central Processing Unit (CPU) or processor 210, a main memory 220, a memory controller 230, an auxiliary storage interface (I/F) 240, and a terminal interface (I/F) 250, all of which are interconnected via a system bus 260. Note that various modifications, additions, or deletions may be made to data server 130 illustrated in FIG. 2 within the scope of the present invention such as the addition of cache memory or other peripheral devices. FIG. 2 is not intended to be exhaustive, but is presented to simply illustrate some of the salient features of data server 130.

Processor 210 performs computation and control functions of data server 130, and comprises a suitable central processing unit (CPU). Processor 210 may comprise a single integrated circuit, such as a microprocessor, or may comprise any suitable number of integrated circuit devices and/or circuit boards working in cooperation to accomplish the functions of a microprocessor. Processor 210 suitably executes one or more software programs contained within main memory 220.

Auxiliary storage interface 240 allows data server 130 to store and retrieve information from various internal and external memory locations, auxiliary storage devices, such as secondary storage device 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a floppy disk drive that may read programs and data from a floppy disk 290.

It is important to note that while the present invention has been (and will continue to be) described in the context of a fully functional computer system, those skilled in the art will appreciate that the mechanisms (particularly database(s) 223 and/or IRB management mechanism 227 of FIG. 2) of the present invention are capable of being distributed in conjunction with compute-readable media, including signal bearing media as one or more program products in a variety of forms, and that the various preferred embodiments of the present invention applies equally regardless of the particular type or location of computer readable media used to actually carry out the distribution. Examples of suitable signal bearing media include: recordable type media such as digital versatile disks (e.g., DVD disk 290) and CD ROM disks, and transmission type media such as digital and analog communication links, including standard network connections and wireless communication links.

In the most preferred embodiments of the present invention, various preferred embodiments of the program product may be configured to communicate with the various entities involved in a typical IRB-related clinical trial application such as: initiating an information request and reply transaction; identifying the participants in the transaction request; creating and updating clinical study data contained in database(s) 223; accessing database(s) 223 to create, update and transmit one or more documents, information requests, etc. In this fashion, the appropriate entities (i.e., Sponsors, Companies, Investigators, SPs, SPAs, etc.) can utilize the program product to initiate and complete a wide variety of information-based transactions related to the management of clinical trials in an IRB setting.

In the most preferred embodiments of the present invention, memory controller 230, through use of an auxiliary processor (not shown) separate from processor 210, is responsible for moving requested information from main memory 220 and/or through auxiliary storage interface 240 to processor 210. While for the purposes of explanation, memory controller 230 is shown as a separate entity; those skilled in the art understand that, in practice, portions of the functions provided by memory controller 230 may actually reside in the circuitry associated with processor 210, main memory 220, and/or auxiliary storage interface 240.

Terminal interface 250 allows users, system administrators and computer programmers to communicate with data server 130, normally through separate workstations or through stand-alone computer systems such as information requesting computer systems 170 and information providing computer systems 180 of FIG. 1. Although data server 130 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bi-directional communication in a computer-related environment could be suitably employed.

Main memory 220 most preferably contains an operating system 221, a web server 222, one or more database(s) 223, an email server 224, a fax server 225, a web interface 226, an IRB management mechanism 227, and a security mechanism 228. The term “memory” as used herein refers to any storage location in the virtual memory space of data server 130.

It should be understood that main memory 220 may not necessarily contain all parts of all components shown. For example, portions of operating system 221 may be loaded into an instruction cache (not shown) for processor 210 to execute, while other files may well be stored on magnetic or optical disk storage devices (not shown). In addition, although IRB management mechanism 227 is shown to reside in the same memory location as operating system 221, it is to be understood that main memory 220 may consist of multiple disparate memory locations. It should also be noted that any and all of the individual components shown in main memory 220 may be combined in various forms and distributed as a stand-alone program product. Finally, it should be noted that additional components, not shown in this figure, may also be included.

The most preferred embodiments of the present invention may also include a security and/or encryption mechanism such as security mechanism 228 for verifying access to the data and information contained in and transmitted by data server 130. For example, security mechanism 228 may be employed to verify and manage encryption for data transmissions as well as providing support for secure sockets layer (SSL) or similar communication protocols.

Additionally, security mechanism 228 may also provide encryption capabilities for computer-based system 100, thereby enhancing the robustness of computer-based system 100. Once again, depending on the type and quantity of information stored in database 223, data server 130 may provide different levels of security and/or encryption for different computer systems 170 and 180. Additionally, the level and type of security measures applied by data server 130 may be determined by the nature of a given request and/or response. In some preferred embodiments of the present invention, database 223 may contained in or implemented in conjunction with certain hardware components (not shown this FIG.) such as hardware-based firewalls, switches, dongles, and the like.

Operating system 221 typically includes the software that is used to operate and control data server 130. In general, processor 210 typically executes operating system 221. Operating system 221 may be a single program or, alternatively, a collection of multiple programs that act in concert to perform the functions of an operating system. Any operating system known to those skilled in the art may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or may develop web servers that are suitable for use with the various preferred embodiments of the present invention. Finally, while depicted as a single device, in certain preferred embodiments of the present invention web server 222 may be implemented as a cluster of multiple web servers. This configuration is generally recognized as providing additional robustness for system uptime and reliability purposes (e.g. for load balancing and redundancy). Regardless of the specific form of implementation, Web server 222 provides system access and, in conjunction with web browser-based user interface 226, to allow individuals and entities to interact with database(s) 223 and IRB management mechanism 227, including communication via network 120 of FIG. 1.

As previously explained in conjunction with FIG. 1, database(s) 223 is used to store information related to the operation and management of clinical trials in an IRB environment. This includes information such as contact information for Sponsors, SPs, SPAs. SMOs, Companies, subjects, and all types of government related information and the forms and documents necessary to track the compliance of the clinical trial with appropriate regulatory requirements. Accordingly, it should be noted that database(s) 223 is representative of any database suitable for storing large quantities of information known to those skilled in the art. Database(s) 223 may be implemented using a standard Relational Database Management System (RDBS), a flat file structure, etc.

In the most preferred embodiments of the present invention, database(s) 223 is a Structured Query Language (SQL) compatible database file capable of storing information relative to the various users and entities that access database(s) 223, including the names, addresses, account preferences, etc. for the users. While database(s) 223 is shown to be residing in main memory 220, it should be noted that database(s) 223 may be physically located in a location other than main memory 220. For example, database(s) 223 may be stored on secondary storage device 270 or DASD 280 and coupled to data server 130 via auxiliary storage I/F 240. Additionally, database(s) 223 may be a segmented database stored in multiple disparate locations.

Web Interface 226 is a specific computer program designed to provide one or more appropriate web browser based user interfaces to IRB management mechanism 227 and, by extension, database(s) 223, via web server 222. In the most preferred embodiments of the present invention, web interface 226 is deployed in concert with web server 222 and provides a graphical user interface that allows the user of IRB management mechanism 227 to use a mouse or similar device to access the desired functions and features of IRB management mechanism 227, including gaining access to the information contained in database(s) 223.

IRB management mechanism 227 is any computer program suitable for the IRB-related management and operational coordination methodologies presented herein. Most preferably, IRB management mechanism 227 is a software application designed to receive, review, format and process requests to receive, store and access information in database(s) 223. Additionally, IRB management mechanism 227 is configured to retrieve, transmit and/or present the information stored in database(s) 223 in a variety of formats, depending on the type of information requested and the type of access authorized in respond to a given request. While IRB management mechanism 227 is shown to be residing in main memory 220, it should be noted that IRB management mechanism 227 may be physically located in a location other than main memory 220. For example, IRB management mechanism 227 may be stored on external storage device 270 or DASD 280 and coupled to data server 130 via auxiliary storage I/F 240.

By extension, each and every parameter necessary to create and/or update any profile found in database(s) 223 may be accessed via IRB management mechanism 227. The creation and update process for the information stored in database(s) 223 may be managed by the individuals or entities that own the information themselves via a standard web browser. The individuals or entities can use their web browser to access IRB management mechanism 227 and, by extension, database(s) 223 via web server 226, thereby creating, updating, exchanging, and otherwise managing the relevant clinical study information for their respective entity.

It should be noted that database(s) 223 and/or IRB management mechanism 227 may be stored at a geographically remote location that is accessible via the Internet, by utilizing any suitable Internet file transfer application (XML, SOAP, etc.). In this type of distributed database environment, database(s) (s) 223 may be implemented using various techniques known to those skilled in the art to prevent data redundancy and to ensure data integrity. Additionally, in the most preferred embodiments of the present invention, information for various file transfer protocols and specifications for communicating with computer systems 170 and 180 of FIG. 1 are also contained in operating system 221 and/or IRB management mechanism 227.

While not required, the most preferred embodiments of data server 130 of FIG. 1 will also typically include a fax server 225. Fax server 225 is any fax server known to those skilled in the art and is configured to receive inbound fax messages and to transmit outbound fax messages. Fax server 225 may format and transmit any fax-formatted data processed by any user of computer-based system 100 of FIG. 1 and make it available for use by any other component of computer-based system 100 of FIG. 1. Additionally, fax server 225 may process the data received and send it directly to IRB management mechanism 227 and make the incoming data available for further processing by computer-based system 100, including IRB management mechanism 227.

While not required, the most preferred embodiments of data server 130 of FIG. 2 will also typically include an email server 224. Email server 224 is any email server application capable of being configured and used to send and receive various status messages and updates between computer systems 170 or 180 of FIG. 1 via email, as may be necessary to enhance the overall process of information management as described herein. This includes the generation of automated email messages relating to the preferred embodiments of the present invention for requests and responses to requests for access to information, etc. Other forms of standard and electronic messaging systems (e.g., instant messaging, phone messaging, telegrams, and the like) may also be utilized in conjunction with the various embodiments of the present invention.

Finally, data server 130 will most preferably include a security mechanism 228 deployed in conjunction with database(s) 223 and IRB management mechanism 227. Security mechanism 228 is deployed generally to authenticate users and deter system abuse. Security mechanism 228 may also incorporate various applications and routines such as firewalls, etc. to prevent unauthorized access to data server 130.

Given the capabilities of the system described in FIG. 1 and FIG. 2, additional explanation and understanding can be provided by way of example. In the first scenario, a Sponsor decides to use computer-based system 100 for providing customized IRB operational management described herein (“IRB SaaS”) for an upcoming study. The Sponsor contacts the IRB offering the IRB SaaS and announces their intention. This notification can be made via phone, fax, mail, email, or directly through the IRB website. Once notified, the Administrative Entity at the IRB will create an SP account based on the submitted information. This will include the creation and assignment of a username and password to allow access to the SP account. Alternatively, in certain preferred embodiments of the present invention, the generation of a password and username may be handled automatically via computer-based system 100 through the use of a “challenge and response” type mechanism.

In addition, while creating an SP account the Administrative Entity will interact with IRB management mechanism 227 to generate two unique codes (STUDY#+Registration Pass Code) for each new clinical trial or study that is to be monitored using computer-based system 100 of FIG. 1 computer-based system 100. The STUDY# code is a unique identifier that is used to reference a specific study. Each study or clinical trial will be assigned its own STUDY#. The Registration Pass Code will be used as a pass code to access the appropriate study. Each Company that has been invited to participate in a clinical trial or study will need to enter both codes when registering for a particular study or clinical trial offered by the associated Sponsor. If either code is incorrect, then the person accessing computer-based system 100 of FIG. 1 computer-based system 100 will not be able to register for a study.

The SP will normally contact Companies directly and alert them to the selection of the IRB as the point of contact for the clinical trial. When the SP makes this contact, they will share the two codes with the Company and the Company will use these codes to register for their clinical trial. The SP may also opt to give the IRB a list of Companies and ask the IRB to contact the Companies directly and share the two codes with them. In any event, if the Company has not previously worked with the IRB SaaS before, they will need to set up their own account with the IRB to access the IRB SaaS. In this scenario, each SP will have a separate user name and password for each clinical trial.

For the next scenario, a given SP is a project manager at Pfizer, a Sponsor. The SP decides to use the IRB SaaS to conduct a series of clinical trials for Pfizer. Further, for purposes of explanation, the SP is going to be running and managing three different trials at Pfizer, using the IRB SaaS. These three studies are denoted STUDY A, STUDY B, and STUDY C. Initially, the SP will contact the IRB to initiate STUDY A. The SP will submit the necessary material and contact information to the IRB, allowing the IRB to create the SP account. Once the account has been created, the SP will receive a user name and password from the IRB for STUDY A. The SP will also receive the two special codes that Companies will need to use if they wish to register for STUDY A. The SP can login into the IRB SaaS, using the user name and password, and see the status of STUDY A. The SP can also view the status of the Companies invited to register and work with the SP on STUDY A.

A few weeks later, the SP is ready to start STUDY B. The SP submits all the necessary information to the IRB, allowing the IRB to set up the SP account for STUDY B. A new username and password will be generated for STUDY B as well as the two special codes for Companies to use when registering for STUDY B. The SP now has two sets of usernames and passwords that can be used to check the status of the two studies (STUDY A & B). However, without further action, the SP will need to log into each account for each study individually. This would require the SP to maintain two sets of usernames and passwords. While manageable, this is not the most preferred embodiment of the present invention.

In order to avoid the use of multiple usernames and passwords, the SP will be designated as an SPA and will be given an SPA account to help facilitate the management of two projects at the same time. With the SP contact information already on file, the IRB will establish an SPA account for the SP running STUDY A and STUDY B. Once the SPA account has been established, the account will then be linked to both STUDY A and STUDY B. The SP can be given a single username and password to access the SPA account and the SPA account will provide access to all of the information for both STUDY A and STUDY B.

The benefit of this approach is that it allows the SPA to see or have access to both STUDY A & STUDY B. The single SPA account will show the SPA everything about each study, from a single account. The SPA will no longer need to access each study individually.

While continuing to manage both STUDY A and STUDY B, the SPA is now ready to submit STUDY C to the IRB. Once again, the SP would submit all the necessary material to the IRB and the IRB would create an SP account for STUDY C. Along with creating the new SP account, the two special codes for Companies to use when registering for STUDY C will also be created. Since the SP for STUDY C already has an SPA account for STUDY A and STUDY B, the IRB will automatically “link” STUDY C to the SPA account and the SPA will not need the SP username and password to access STUDY C because the SP will have access to STUDY C through the SPA account. This process can be continued indefinitely, allowing a single SPA to access multiple clinical trials with a single username and password. This greatly simplifies the management of multiple simultaneous clinical trials for the SPA.

In next example, the supervisor for an SPA is a senior level director at a major pharmaceutical company. The supervisor oversees five different project teams and each project team has an SP overseeing a different clinical trial. The IRB has already received the necessary information for each of the five clinical trials and has already created 5 separate SP accounts, one for each clinical trial underway. If the Supervisor wants to see the status of a given clinical trial, the supervisor would normally be given the username and password for the clinical trial in order to access the information. This approach would require 5 sets of usernames and passwords to be maintained by the supervisor the supervisor would have to log into the account for each of the clinical trials separately. However, by collecting some contact information from the supervisor, the IRB may establish an SPA account for the supervisor, which would be “linked” to each of the five clinical trials her subordinates are working on. This will now give the supervisor a single username and password with the ability to access the information fro all five clinical trials from a single account.

Administrative Entities at the IRB are able to link and unlink the SP accounts that are associated with SPA accounts as needed. Accordingly, if Project teams change and or are merged, linking and unlinking the different SP accounts can be easily accomplished.

When a Company has been approached directly by the SP (or through the IRB at the request of the SP) about registering for a given study, the Company will need to enter their contact data and related Company identifying information into database 223 via web interface 226. The Company can then utilize the two pass codes they will need to register for a particular study or clinical trial.

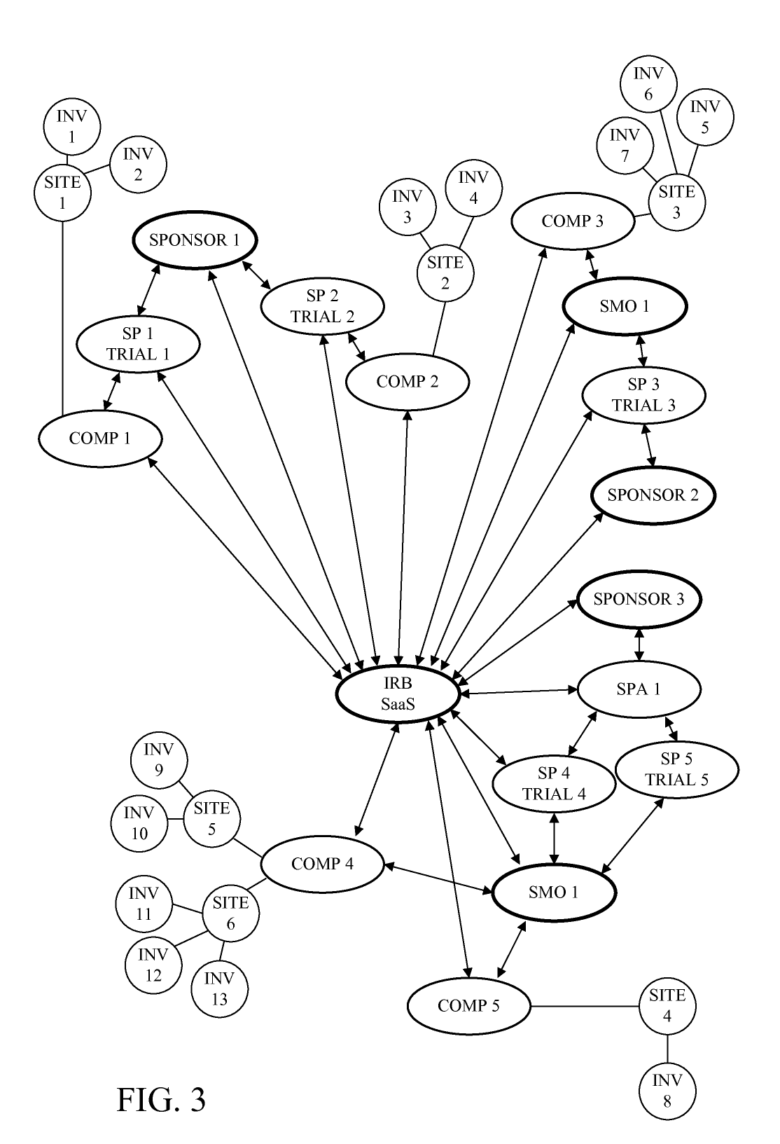

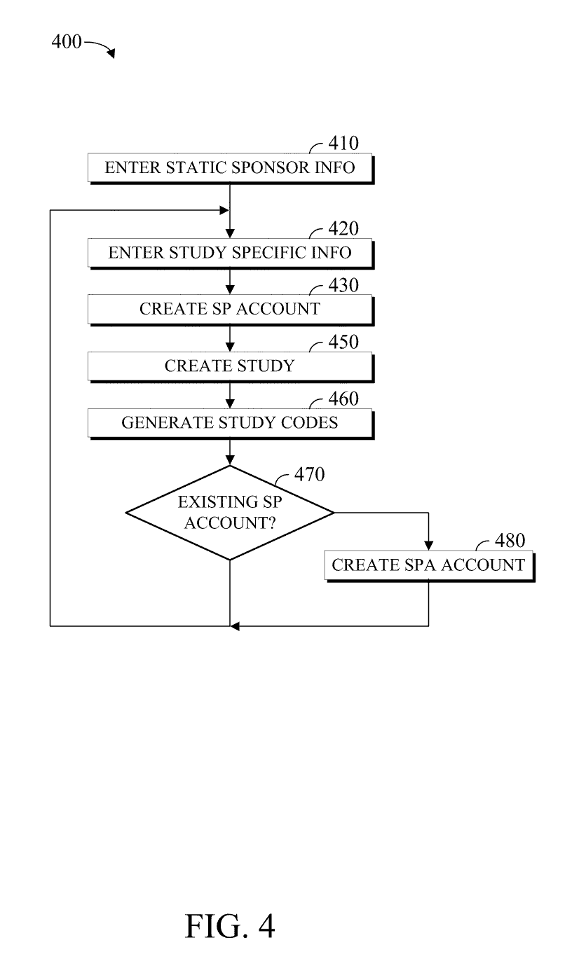

Referring now to FIG. 3, a schematic relationship diagram 300 illustrates the basic relationship of the various parties using a customized IRB operational management system for clinical trials accordance with a preferred embodiment of the present invention. As shown in FIG. 4, for this example, there are three different Sponsors (Sponsor 1, Sponsor 2, and Sponsor 3). Sponsor 1, with SP 1 as the project manager, has elected to employ Company 1 to conduct clinical trial or study TRAIL 1. Similarly, Sponsor 1, with SP 2 as the project manager, has elected to employ Company 2 to conduct clinical trial or study TRAIL 2. Company 1 operates TRIAL 1 at Site 1, with Investigator 1 and Investigator 2 being the medical professionals involved in the actual conducting of TRIAL 1. Similarly, Company 2 operates TRIAL 2 at Site 2, with Investigator 3 and Investigator 4 being the medical professionals involved in the actual conducting of TRIAL 2.

Moving now to Sponsor 2, SP 3 has been designated as the SP for TRIAL 3 and has engaged Company 3 to conduct TRIAL 3 at Site 3, using Investigators 5, 6, and 7. Sponsor 2 has also elected to engage SMO 1 to handle various documentation and logistical activities associated with TRIAL 3.

Reviewing diagram 300 for information for Sponsor 3, it should be noted that Sponsor 3 has also elected to contract with SMO 1 to assist Sponsor 3 with the management of two additional clinical trials, TRIAL 4 and TRIAL 5. Additionally, Sponsor 3 has identified a project manager as an SPA and SPA 1 is responsible for managing both TRIAL 4 and TRIAL 5. TRIAL 4, with an SP 4 designation, is being conducted by Company 4 at Site 5 and Site 6 with investigators 9-13. Similarly, TRIAL 5, with an SP5 designation, is being conducted at Site 4 by Company 5. Regardless of the identity of the various participants, all clinical trials are being conducted in conjunction with an IRB that is using the IRB SaaS of the present invention. This allows each entity involved in the study or clinical trial to have a central point of contact for communications regarding the various clinical trials and to have access to all relevant documents related to the clinical trials. The security and access features of the IRB SaaS limit access to the materials, ensuring that only authorized personnel can access the documents that are approved for their study and their specific role in completing the study.

Those skilled in the art will recognize that providing the ability for Sponsor 1, Sponsor 2, Sponsor 3, SP1, SP 2, SP3, SPA 1, SMO 1, Comp 1, Comp 2, and Comp 3 to each interactively, asynchronously, and independently interact with IRB SaaS, is a significant benefit to the entities involved in the study and offers many benefits over the present state-of-the-art.

Referring now to FIG. 1, FIG. 2, and FIG. 4, a method 400 for initiating a new SP managed clinical trial with an IRB using a customized IRB operational management system for clinical trials accordance with a preferred embodiment of the present invention is shown. The methods described herein can be implemented and completed via IRB management mechanism 227 of FIG. 2. As shown in FIG. 4, once a determination has been made to utilize the IRB SaaS process, the Sponsor will communicate with the IRB and use web interface 226 of FIG. 1 to enter the basic Sponsor information (step 410), including location, contact person, etc. This basic information is considered to be fairly static and, accordingly, can be saved in database 223 of FIG. 1 and used again for future clinical trials. This reduces the amount of time necessary to initiate additional clinical trials with the same Sponsor.

Next, the information that specifically relates to the proposed clinical trial or study can be added to database 223 of FIG. 1 (step 420). This information is used to identify the specific clinical trial and will be combined with the static information for the Sponsor that was previously provided to create the SP account for this specific clinical trial (step 430) and the SP will be issued a username and password for accessing the SP account. With this information, the actual study record can be created in database 223 of FIG. 1 (step 450).

At this point in time, the study codes that will be used to both identify the study and to allow one or more Companies to register for the study are generated by the IRB SaaS (step 460). As previously explained, one of the codes identifies the specific study and the other code acts as a password that must be entered by any Company that has been invited to participate in the study. Without both codes, no Company will be able to access the study. This provides an additional level of security for the study and prevents unauthorized entities from viewing the contents of the study record and allows the SP to limit the access to the information for the study to only those Companies that will be invited to participate in the Study.

Once the SP account has been created, it is possible to check database 223 of FIG. 1 to ascertain whether or not there are one or more existing SP accounts already made of record for the Sponsor of the clinical trial. If there are already one or more SP accounts for the Sponsor in database 223 of FIG. 1, it may be desirable to create an SPA account and link the new SP account to the SPA account, thereby allowing a single project manager to manage multiple projects with a single password and username. This step, while optional, will provide useful for many Sponsors that assign multiple studies to a single project manager. Additionally, by establishing a separate SP account as well as an SPA account, the Sponsor can provide access to the SP account or the SPA account, depending on the specific needs of the Sponsor.

As shown in FIG. 4, this process can be repeated for as many studies as desired. However, since the Sponsor has previously entered the static information regarding the Sponsor into database 223 of FIG. 1, it will not be necessary to re-enter this information again. Instead, the Sponsor can simply enter the study specific information and quickly and easily create a new study.

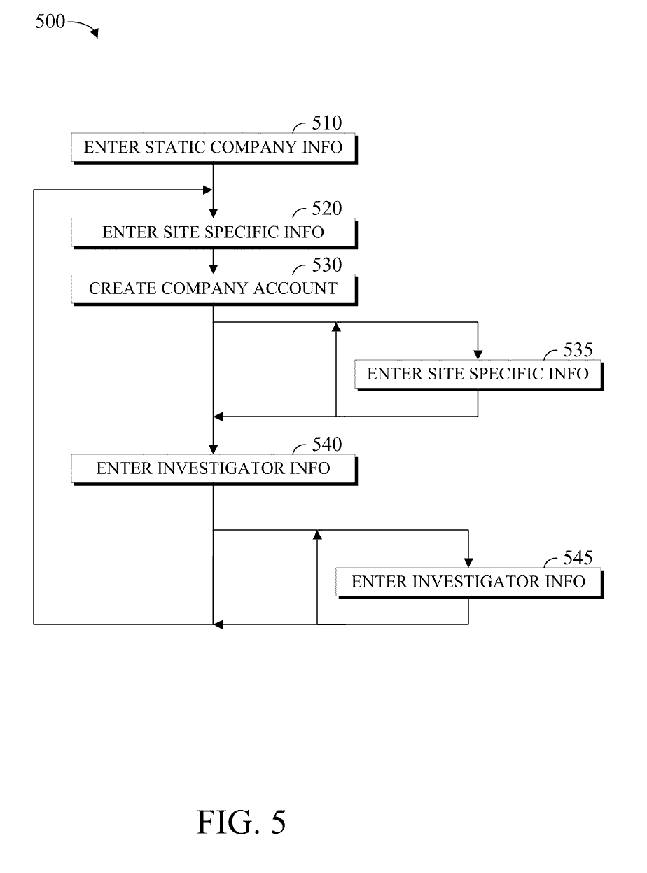

Referring now to FIG. 1, FIG. 2, and FIG. 5, a method 500 for adding a new Company to database 223 of FIG. 1 so that the Company can participate in a clinical trial at an IRB using a customized IRB operational management system for clinical trials accordance with a preferred embodiment of the present invention is shown. The methods described herein can be implemented and completed via IRB management mechanism 227 of FIG. 2. As shown in FIG. 5, the basic or mostly static information regarding a company is entered into database 223 of FIG. 1 using web browser interface 226 of FIG. 1 (step 510).

Next, Site-specific information will be added to the record (step 520) so that a company account can be created (step 530). Part of the creation process involves providing a username and password that can be used to access the Company account. From this point, the Company can add multiple Sites to the Company account (step 535), if desired. Once again, it will not be necessary to re-enter the static Company information again because the static Company information can simply be accessed as necessary for each new Site that is to be added. This process ties each Site to a specific Company. In general, prior to adding an account, it will be necessary to have at least one Investigator and at least one Site associated with a proposed study prior to entering a creating a new study in the system.

Additionally, the Company can add Investigator information for a single Investigator (step 540) or multiple Investigators (step 545). Similar to adding additional Sites, when adding a new Investigator, it will not be necessary to re-enter the Company information again because the static Company information can simply be accessed as necessary for each new Investigator to be added to the Company's record. This process ties each Investigator to a specific Company and to a specific Site.

Further, instead of the manual process used in registering for multiple studies that is typical in the IRB industry today, the static Company information of the present invention can be considered as a type of overall Company “profile” and can significantly reduce the amount of time and effort required to register for additional future studies. For example, a Company may have 4 or 5 Sites and multiple Investigators at any given Site. Once the overall Site and Investigator information has been entered, the exact combination or “team” of Sites and Investigators needed to qualify for and perform a given study can be assembled and submitted electronically in minutes. This allows a Company to quickly and easily provide the necessary information for a given study without re-entering any previously supplied data. The information, once submitted, can be reviewed by the Sponsor and the Administrative Entity as well, thereby providing access to the necessary information in a most rapid and efficient manner.

Additionally, once all of this information has been entered, the Company can utilize the two access codes provided by the Sponsor to access the IRB SaaS and request access to the study identified by the access codes. In addition, the Company can begin to add documents to the study in order to meet the requirements of the study. The SP can monitor the activities of the Company and follow the progress of the Company as the Company fulfills the requirements of the study.

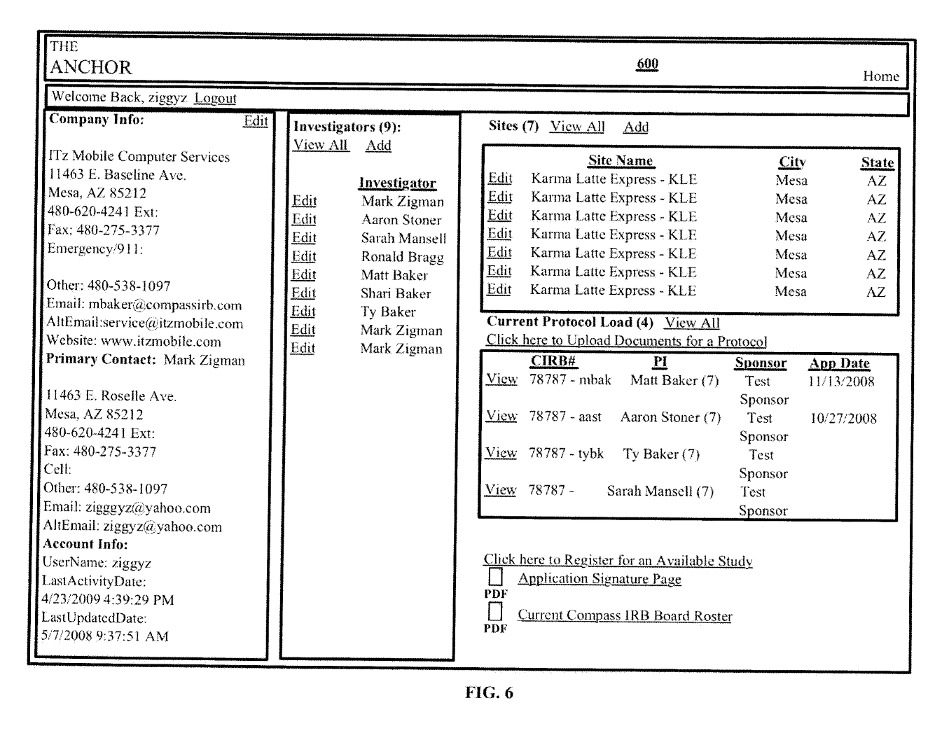

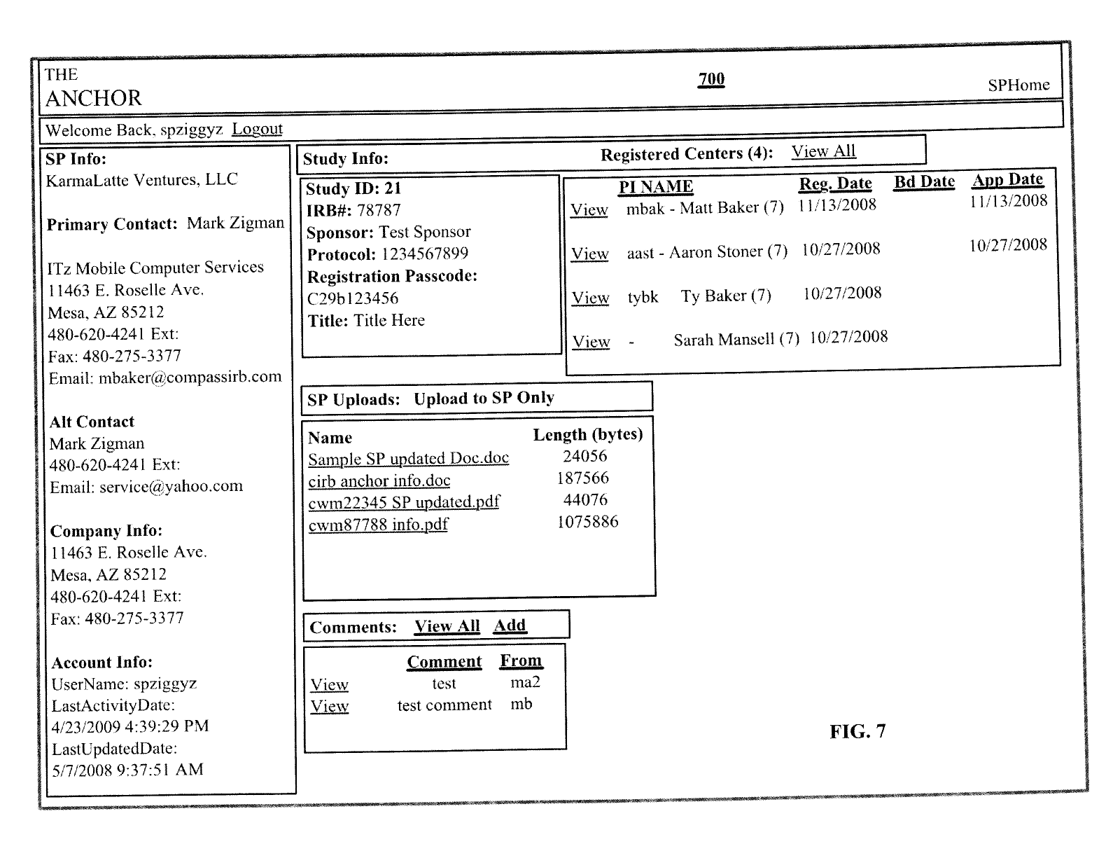

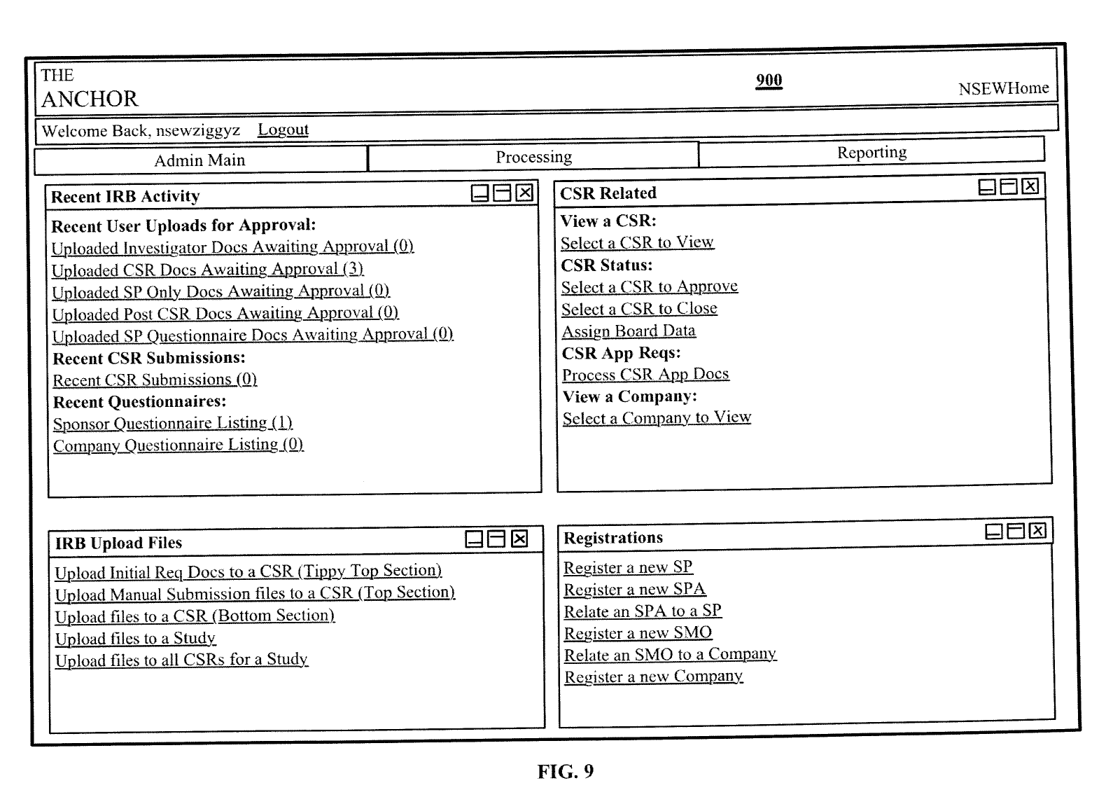

Once a study has been initiated, and the approval process completed, all of the participants will have access to the pre-determined view of the information that relates to the study. For example, the Company will have access to a series of views of the Company related data that will allow the Company to quickly and easily see which investigators are working on which studies. Additionally, the Company can add, modify, or delete information as necessary to maintain necessary records and remain compliant with requests from regulatory agencies. Various views for the system are set forth in FIG. 6, FIG. 7, FIG. 8, and FIG. 9.

Additional system level safeguards include the ability to review and screen documents and credentials to enhance regulatory compliance. For example, if a document submitted for a clinical trial is too old, it may be rejected by the system. Similarly, if a proposed Investigator does not have the appropriate medical licenses or other necessary credentials, the Investigator may be rejected by the system. Depending on the clinical trial, there may be different critical elements that will be addressed by the system. This will allow for customization of systems and processes to ensure that the necessary elements are present for each and every clinical trial or study. All of the documents, reports, updates, etc. supplied by IRB SaaS can be transmitted and output to one or more of the output devices referenced in FIG. 1 (e.g., printer 110, fax machine 140, or the display of computer 170, computer 180, or PDA 190), thereby providing a feedback mechanism to the user of computer-based system 100.

One of the most useful aspects of the present invention is the opportunity for all authorized entities to view and monitor the flow of information into the study. By observing which documents are being added to the study over time, all participants will know exactly what documents and approval steps are necessary to move the study forward. Additionally, by activating an automatic notification mechanism within IRB management mechanism 227 of FIG. 2, alerts can be issued via email server 224 of FIG. 2. These email alerts can be triggered by the arrival of certain documents, the approval or disapproval of certain documents, etc. This allows each participant to be fully aware of the progress of the clinical trial at each stage, thereby providing opportunities to make adjustments and corrections as necessary.

Referring now to FIG. 6, a user interface 600 for viewing and updating various aspects of a clinical trial from the perspective of a Company using a computer-based system for providing customized IRB operational management in accordance with a preferred embodiment of the present invention is depicted. As shown in FIG. 6, a Company can review the relevant information for any given clinical trial being conducted by the Company. The Company can register Investigators, edit Investigators, as well as upload relevant documents for validating the Investigators eligibility for participation in a clinical trial. Similarly, the Company can add Sites and modify the information for one or more Sites. The Company can also add documents for a given protocol and view all documents that are necessary as well as view a “missing documents” listing that will highlight the documents that must be submitted during any phase of the clinical trial. This allows the Company to focus on identifying and providing the relevant documents in a timely fashion so as to ensure the clinical trial proceeds to completion as rapidly as possible. User interface 600 is one example of a preferred exemplary embodiment of web interface 226 of FIG. 2.

Referring now to FIG. 7, a user interface 700 for viewing and updating various aspects of a clinical trial from the perspective of a Service Provider using a computer-based system for providing customized IRB operational management in accordance with a preferred embodiment of the present invention is depicted. As shown in FIG. 7, a Service Provider has ready access to all of the relevant information for a given clinical trial. The SP can upload relevant documents during the process of conducting the clinical trial as the documents become available. Similarly, the SP can view the information for a given study and the related documents for a Company, the CSRs for that Company, and the relevant Sites and Investigators for the specific study accessed by the SP via the SP username and password. The SP can also upload study-related documents for a given protocol and view all documents that are necessary as well as view a “missing documents” listing that will highlight the documents that must be submitted during any phase of the clinical trial. This allows the SP to focus on identifying and providing the relevant documents in a timely fashion so as to ensure the clinical trial proceeds to completion as rapidly as possible. User interface 700 is one example of a preferred exemplary embodiment of web interface 226 of FIG. 2.

Referring now to FIG. 8, a user interface 800 for viewing and updating various aspects of a clinical trial from the perspective of a Service Provider Administrator using a computer-based system for providing customized IRB operational management in accordance with a preferred embodiment of the present invention is depicted. As shown in FIG. 8, in addition to all of the features of the SP user interface, the SPA can view the information for multiple studies for a single user interface. This allows the SPA to quickly and efficiently find and review the necessary information for any clinical trial that is underway. It is especially useful to see the document status portion of the user interface so that the SPA can identify any missing documents and focus on providing the needed input in a timely fashion so as to ensure that each clinical trial proceeds forward in an expeditious fashion. User interface 800 is one example of a preferred exemplary embodiment of web interface 226 of FIG. 2.

Referring now to FIG. 9, a user interface 900 for viewing and updating various aspects of a clinical trial from the perspective of a Administrative Entity using a computer-based system for providing customized IRB operational management in accordance with a preferred embodiment of the present invention is depicted. As shown in FIG. 9, the Administrative Entity can review multiple in-process clinical trials from a single user interface. In addition, the Administrative Entity can review the status of documents that have been submitted, approve documents that have been submitted, review multiple CSRs, approve and close CSRs, all from a single user interface. User interface 900 is one example of a preferred exemplary embodiment of web interface 226 of FIG. 2.

In summary, the present invention provides broad application of a unique process for managing clinical trials in an IRB environment while providing opportunities for various entitles to store and retrieve study related information and offering customized views of that information via computer networks such as the Internet. While the various preferred embodiments of the present invention have been described in conjunction with IRB management-related information, those skilled in the art will appreciate that the apparatus and methods of the present invention are suitable for deployment in other areas as well.

For example, the inclusion of additional elements such as the use of bar code reading and electronic signatures are also contemplated by the various preferred embodiments of the present invention. The use of automatic document generation to complete required forms is also considered within the scope of the present invention.

Lastly, it should be appreciated that the illustrated embodiments are preferred exemplary embodiments only, and are not intended to limit the scope, applicability, or configuration of the present invention in any way. Rather, the foregoing detailed description provides those skilled in the art with a convenient road map for implementing a preferred exemplary embodiment of the present invention. Accordingly, it should be understood that various changes may be made in the function and arrangement of elements described in the exemplary preferred embodiments without departing from the spirit and scope of the present invention as set forth in the appended claims.

1. An apparatus for use in an independent review board environment comprising:
at least one processor;
at least one memory coupled to said at least one processor;
a database residing in said at least one memory; and
a management mechanism residing in said memory, said management mechanism being configured to:
store basic information for a clinical trial being conducted by a sponsor in and said database;
store study specific information for said clinical trial in said database;
create a service provider account for said clinical trial;
generate a username and password for said service provider account;
generate a pair of unique codes for said clinical trial, said user name and said password and said pair of unique codes being used to access or update information relative to said clinical trial.

2. The apparatus of claim 1 further comprising a web interface for accessing said database and said information relative to said clinical trial.

3. The apparatus of claim 1 further comprising a forms mechanism, said forms mechanism being configured to render one or more forms containing information from said database.

4. The apparatus of claim 1 wherein said pair of unique codes for said clinical trial comprises:
a first code, said first code identifying a specific clinical trial; and
a second code, said second code being used to permit one or more companies to register for participation in said specific clinical trial.

5. The apparatus of claim 1 further comprising:
a web interface for accessing said database and said information relative to said clinical trial;
a forms mechanism, said forms mechanism being configured to render one or more forms containing information from said database; and
wherein said pair of unique codes for said clinical trial comprises:
a first code, said first code identifying a specific clinical trial; and
a second code, said second code being used to permit one or more companies to register for participation in said specific clinical trial.

6. The apparatus of claim 1 further comprising at least one of a web server residing in said at least one memory, an e-mail server residing in said at least one memory, a fax server residing in said at least one memory, and a security system residing in said at least one memory.

7. The apparatus of claim 1 further comprising:
a web server residing in said at least one memory;
an e-mail server residing in said at least one memory;
a fax server residing in said at least one memory; and
a security system residing in said at least one memory.

8. The apparatus of claim 1 wherein said basic information and said study specific information are combined to identify a specific clinical trial and wherein said pair of unique codes comprises:
a first code, said first code identifying a specific clinical trial; and
a second code, said second code being used to permit one or more companies to register for participation in said specific clinical trial.

9. A computer-implemented method for managing a clinical trial being conducted by a sponsor in conjunction with an independent review board comprising the steps of:
a) storing basic information relative to said clinical trial in a database;
b) storing study specific information relative to said clinical trial in said database;
c) creating a service provider account for said clinical trial;
d) generating a username and password for said service provider account;
e) generating a pair of unique codes for said clinical trial, said user name and said password and said pair of unique codes being used to access or update information relative to said clinical trial; and
f) displaying said pair of unique codes on at least one of a computer screen, a printer, or a fax machine printout, said unique pair of codes being used by a user to access information relative to said clinical trial.

10. The method of claim 9 wherein said pair of unique codes for said clinical trial comprises:
a first code, said first code identifying said clinical trial; and
a second code, said second code being used to permit one or more companies to register for participation in said clinical trial.

11. The method of claim 9 further comprising the step of accessing said database and said information relative to said clinical trial via a web server and a web interface.

12. The method of claim 9 further comprising the steps of:
repeating steps a-f to create a plurality of service provider accounts; and
creating at least one service provider administration account, said at least one service provider administration account being configured to provide access to said plurality of service provider accounts via a single user interface and a single username and password.

13. The method of claim 9 further comprising the steps of:
accessing said database;
creating at least one form for said clinical trial using said basic information and said study specific information relative to said clinical trial; and
displaying said at least one form on at least one of a computer screen, a printer, and a fax machine.

14. The method of claim 9 further comprising the step of using said username and said password and said pair of unique codes to register for said clinical trial.

15. The method of claim 9 further comprising the steps of:
creating a plurality of service provider accounts;
creating at least one service provider administration account to access said plurality of service provider accounts; and
creating at least one SMO account.

16. The method of claim 9 further comprising the step of using a security mechanism to restrict access to said database, access being granted to said database only upon authentication using each of said username, and said password, and said pair of unique codes.

17. The method of claim 9 further comprising the step of providing a plurality of user interfaces for accessing said database, wherein said plurality of user interfaces provides a different view of the information in said database.

18. A computer-readable medium encoded with a computer program for organizing and presenting information relating to at least a first clinical trial being conducted in conjunction with an independent review board, the computer program comprising an IRB management mechanism, said IRB management mechanism being configured to:
store basic information relative to said at least a first clinical trial in a database;
store study specific information relative to said at least a first clinical trial in said database;
create a service provider account for said at least a first clinical trial;
generate a username and password for said service provider account;
generate a pair of unique codes for said at least a first clinical trial, said user name and said password and said pair of unique codes being used to access or update information relative to said at least a first clinical trial; and
display said pair of unique codes on at least one of a computer screen, a printer, or a fax machine printout, said unique pair of codes being used by a user to access information relative to said at least a first clinical trial.

19. The computer-readable medium of claim 18 wherein said IRB management mechanism is further configured to create a plurality of service provider accounts and at least one service provider administration account, said at least one service provider administration account being configured to provide access to said plurality of service provider accounts via a single user interface.

20. The computer-readable medium of claim 18 wherein said computer-readable medium comprises at least one of recordable media and transmission media.
